(19) United States
(12) Patent Application Publication
(10) Pub. No.: US 2015/0133175 A1
(43) Pub. Date: May 14, 2015

(54) System for building and using a fingerprint database to localize accessed data

(71) Applicant: William Stryker Clausen, Kirkland, WA (US)

(72) Inventor: William Stryker Clausen, Kirkland, WA (US)

(73) Assignee: CARTOGRAM LLC, Kirkland, WA (US)

(21) Appl. No.: 14/534,478

(22) Filed: Nov. 6, 2014

Related U.S. Application Data
(60) Provisional application No. 61/902,287, filed on Nov. 10, 2013.

(51) Int. Cl. H04W 4/04; G06F 3/0484; G06F 3/0488

(52) U.S. Cl. CPC H04W 4/043; G06F 3/0488; G06F 3/04842
USPC 455/457

(57) ABSTRACT

A system collects localized data of elements relative to containers into a fingerprint database memory and stores dynamic input maps where the maps can be grid based or relevance factor based. The input maps represent input data or outputs from algorithms regarding the elements in known relation to reference points for a plurality of containers. A touchscreen user interface is used for configuring the display of the dynamic input maps and the containers with a plurality of container attributes, for inputting a plurality of additional data regarding the elements and the containers and for displaying the dynamic input maps. A processor receives data inputs and builds the database concerning the element attributes and the container attributes and builds the dynamic input maps and processes relevance factors regarding the data. Algorithms can be used to rank relevance factors and create specific displays.

### CROSS-REFERENCE TO RELATED APPLICATIONS

This application claims priority to copending U.S. Provisional patent application No. 61/902,287 entitled Methods for Interacting with an Indoor Positioning System filed on Nov. 10, 2013, which provisional application is incorporated herein by reference in its entirety; this application claims the benefit of the provisional's filing date under 35 U.S.C. 119(e).

### STATEMENT REGARDING FEDERALLY SPONSORED RESEARCH OR DEVELOPMENT (IF APPLICABLE)

Not Applicable

### REFERENCE TO SEQUENCE LISTING, A TABLE, OR A COMPUTER PROGRAM LISTING COMPACT DISC APPENDIX (IF APPLICABLE)

Not Applicable

### FIELD OF THE INVENTION

The present invention is an improvement to an indoor positioning system (‘IPS’) that uses a broader scope of inputs to measure more than just position in order to facilitate a broader scope of application uses for the broader scope of data collected.

### BACKGROUND OF THE INVENTION

Prior art indoor positioning systems (IPS) are typically a service for determining the simple position of an object on or inside a structure using a grid. Prior art methods involve tracking simple position via a mobile terminal using a combination of sensors, wireless technology, dead reckoning, signal measurements, and user input and may involve a great deal of calibration that make it difficult to use for the general public.

### BRIEF SUMMARY OF THE INVENTION

Simple position tracking can be useful for tracking elements, namely living things and/or objects.

Going beyond simple position tracking to mapping in a fingerprint database allows the user to potentially be able to use grid-related or nongrid related ‘containers’ to see the elements and/or activity of other elements in specific rooms, room types, buildings, building types, areas, area types, floors, floor types, wings, wing types, or any other subsection or type of subsection of a structure, where the data emanating from said subsection can be from structures in different geographical areas (non-grid related).

A fingerprint database can be defined as a data resource for reading and writing wireless and electrical signal characteristics that represent aspects of physical characteristics for tracking elements (people, animals, objects, etc.) and/or activities inside a building.

### BRIEF DESCRIPTION OF THE SEVERAL VIEWS OF THE DRAWING

FIG. 1 is a drawing of a user's mobile terminal screen

FIG. 2 is a drawing of a person taking a picture with a mobile terminal being input to a fingerprint database

FIG. 3 is a drawing of an operator's mobile terminal screen

FIG. 4 is a drawing of a property owner's mobile terminal screen

### DETAILED DESCRIPTION OF THE INVENTION

Definition: Fingerprint database: A fingerprint database can be defined as a data resource for reading and writing wireless and electrical signal characteristics that represent aspects of physical characteristics for tracking elements (people, animals, objects, etc.) or activities inside a building.

For instance, an element or activity in a building might be identified by its MAC address, its visual characteristics, the sounds it makes, its temperature, or any characteristic which can be identified by an entity capable of object recognition, such as a human, computer, sensor or animal. The identifiable element or activity may be defined. in the fingerprint database as having a wireless signal strength of −84 at a particular latitude and longitude, on a particular floor or area inside of a building. One or more characteristics of the identifiable object will be stored in the fingerprint database and may be referenced in the future for a variety of situations, including determining the position of the identifiable object as well as in determining the position of an object other than said identifiable object.

Inputs to the fingerprint database can be direct such as content, activity, or events from a user's mobile terminal or social networking content or lists of objects in a room or may be raw or conditioned data such as outputs from proximity or inertial sensors, camera data, presence, text messages, mails, data sent or received from the mobile terminal, and recognition of specific combinations, trends, or lack of one or more pieces of content, activities, or events.

Definition: Container: A container is a grouping of data from the fingerprint database that may be represented by the grid-type or non-grid-type mapping of buildings or GPS data or some other collection of data. A fingerprint container contains a set of data grouped and ranked together by the user where the group is not necessarily geographically or grid related.

Definition: Relevance factors—Relevance is determined by each individual application of the invention where examples include personal, political or a revenue-related factors.

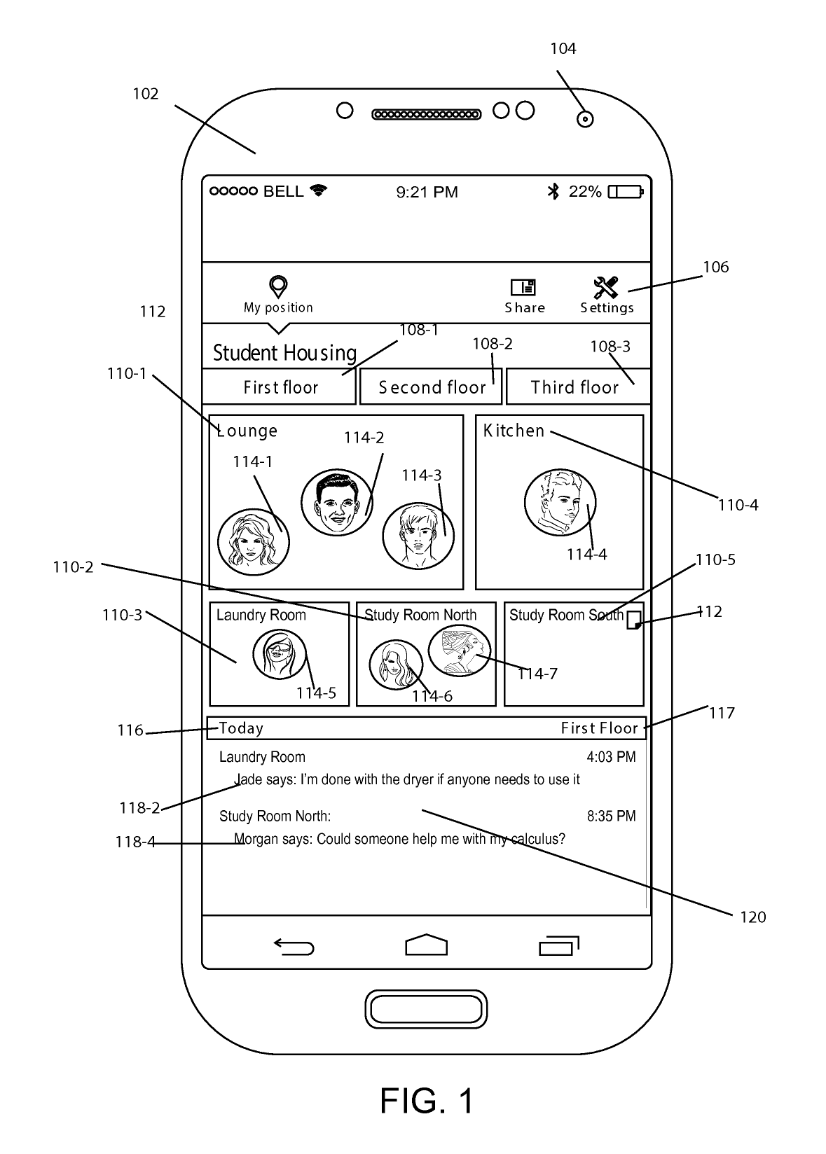

FIG. 1 is an example of how a fingerprint database system could be presented to a user, where each container is a room with its own activity and where the users present in the room and the activity of those users is displayed. Note that in this example, all of the containers displayed are on the first floor of the building and that more rooms may be present by scrolling the room containers left/right/etc. Also note that the rooms may or may not be in a specific order and that this disclosure is not limited to the arrangement shown in this view.

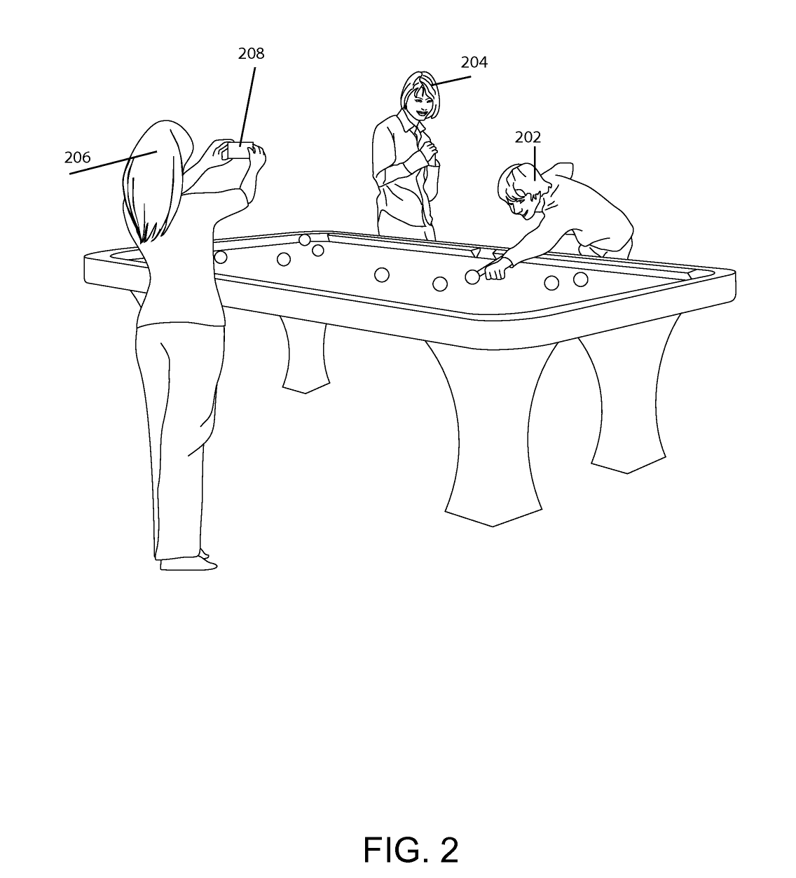

FIG. 2 is a drawing of a person taking a picture with a mobile terminal being input to a fingerprint database.

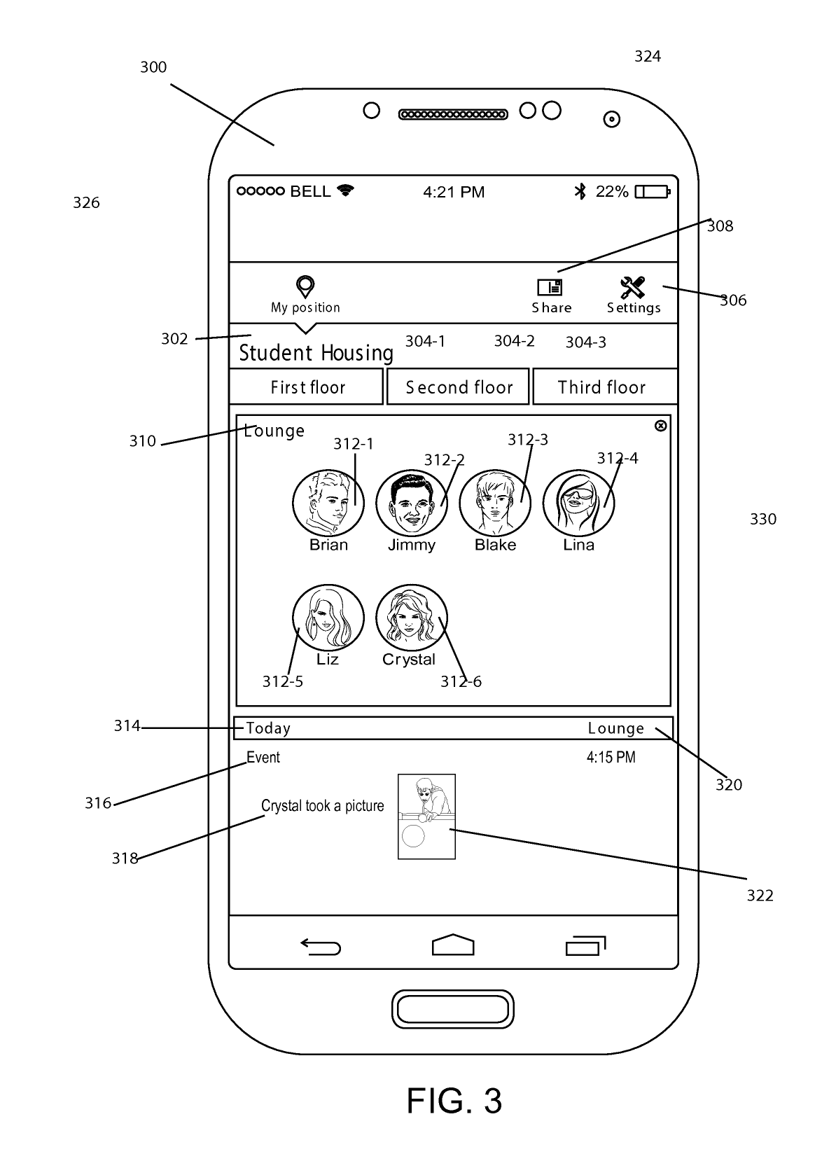

FIG. 3 shows a mobile terminal with a representation of a user interface for a fingerprint database, where the view has been changed to represent the activities and events occurring in the one of the containers, the lounge. Note how the picture take from FIG. 2 is shown here. This is an example of where the data is owned and managed by the operator and/or owner of the fingerprint database rather than a user or group of users.

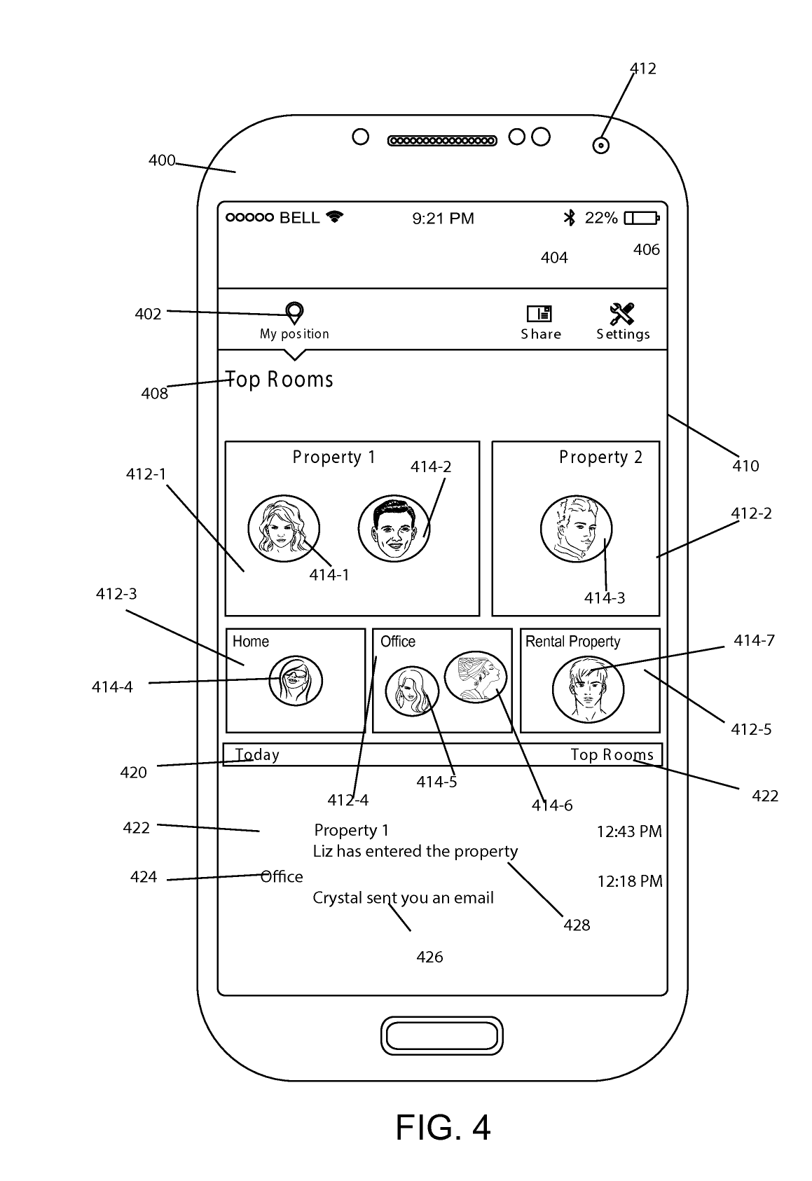

FIG. 4 shows a mobile terminal with a representation of a user interface for a fingerprint database which supports the simultaneous display of multiple containers, where the containers or rooms may or may not be in the same building. The view is labeled “Top Rooms”, implying that the rooms may have been displayed due to rank assigned to the room from the fingerprint database.

Since it is possible to display different rooms from different structures with such a fingerprint database, users may not want to spend the time and effort consistently viewing every room of interest in every building tracked by the fingerprint database. As such, the fingerprint database can rank rooms based on a number of factors, including how interested the fingerprint database thinks the user would be in viewing the content coming from a specific room.

Such events or activities can be tied in a database for the building's subsection rather than to the person performing said event or activity. For instance, a user taking a picture in the a living room would initiate a connection in the fingerprint database between the living room and the picture, data, where the living room would be the owner of the picture data and the living morn would be owned by the entity operating the fingerprint database.

A type of room can be distinguished from a room in that a room has a relative location inside a specific structure where a type of room represents all rooms which serve a specific purpose or have a specific name. A type of room does not have a geographical location.

The actual positions of users or objects in a room can be combined to form a new view of said room. For instance, consider a restaurant chain where all of the floor plans are the same (or roughly the same). The owner or manager of the restaurant could see the workers at all the chain's restaurant in a single view and get insights about how to better run his or her business.

In another embodiment of the present invention, a room or subsection of a building can be grouped in more than one room type and a room type may be split into subtypes. For instance, a “Living Room” type and a “Lounge” type may both be subsets of a room type of “Fun” or “Social” or “Living Area” or the like.

FIG. 1 is a diagram representing an example of a user interface for the present disclosure. The mobile terminal 102, which may consist of at least one control unit, display, storage unit, input unit, sensor unit, and communication mechanism, shows an entry point for viewing the activity inside a group of rooms, 110-1 through 110-5, and the aggregate data emanating from said group of rooms 120 (e.g., a virtual wail or activity feed) characterized by the people in said rooms, 114-1 through 114-7 and floor of said rooms 117.

It is important to note that depending on the implementation of the user interface shown in FIG. 1 the visual depiction on the rooms of a given floor may or may not represent a map, as the representation of the subsections of a structure may or may not be ordered. An unordered collection of unconnected containers would not he representative of a map, whereas an ordered collection of containers would be at least a rough representation of a map.

FIG. 2 shows a diagram of people in building subsection called “Lounge”, where the name of the room represented is “Lounge” and the type of room is “Lounge”. Note that the type of room “Lounge” can represent more than one room which is of type “Lounge” or a subset of the room type “Lounge”, where data could be aggregated and displayed from one or more rooms of type “Lounge”.

Users may subscribe to container types, similar to the way that users can currently subscribe to hashtags on Twitter.

FIG. 3 shows a diagram of an example of a user interface which has narrowed data to the events of a particular room or subsection of a building. This view is a core part of the invention, as it demonstrates the data belongs to the particular room or structure subsection as opposed to belonging to a business or person. Only those with access to said room in the indoor-positioning system' s internal settings would be able to view said data, which could limit the viewing of data in a room or room type by a variety of factors.

Factors for qualifying for viewing a particular room could include proximity to the geographic location of the room (e.g., if you're in the same building) or if you're in proximity to the type of room being considered (e.g., a user might be able to see data emanating from one or more kitchens in the fingerprint database if he or she is near a room of type kitchen)

The mobile terminal 208 in FIG. 2 is representative of the mobile terminal represented in FIG. 3 by element 300. The person named “Crystal” in FIG. 2 by element 206 is shown taking a picture in the “Lounge” room and “Lounge” room type. Since 206 is taking a picture in the “Lounge” room, the picture is shown only on the wall/activity feed 318 shown as 322, 206 is represented as 312-6 in FIG. 3.

FIG. 4 represents a diagram of a fingerprint database which shows subsections of buildings, where the buildings are in different geographic locations and where the building subsections 412-4 through 412-5 are not of the same granularity with respect to general area size. For instance, the users 414-1 and 414-2 are shown merely to be present in a property 412-4, but their rooms and/or room types are not displayed. However, the “Office” room, shown as 412-4, is representing a room “Office” which may also be of room type “Office”, which may or may not be in a different building as 412-4, 412-2, 412-3, and 412-5.

Note that the users shown in the building subsections and rooms can be shown in an ordering of position in said location, but need not be.

FIG. 4 also represents a view of building subsections, such as rooms, which could be displayed in accordance to a ranking algorithm based on the data emanating from rooms in a database, known data about the user and the user's surroundings, and data about the events and people and activities which are occurring in the building subsections known to the fingerprint database.

In an embodiment of the present invention, the ranking algorithm may display rooms based on the users and objects present in building subsections and rooms and the relationship of those users and objects to the present user. For instance, if a “Lounge” room type had 23 different friends or connections and the Property 2 shown in 412-2 had only one user, the system might show 412-2 because the user programmed the display to display revenue relevance. Or, the algorithm may choose to show the “Lounge” room type because of the personal connections present in said room type. Or, the algorithm might choose to show them both. Or, the algorithm may choose to show neither of them due to other rooms or subsections which may be deemed as having a higher relevance.

The algorithm may be influenced by a number of factors, including but not limited to, the weather or environmental conditions in, surrounding, or near a room or room type, money paid by users or businesses to modify the ranking of a room or room type, the amount of time spent in a room by one or more users or one or more groups of users or one or more groups of objects or the likelihood of time being spent in a room or room type by users or the expressed wish of users for other users to spend type in a room or type of room.

The algorithm may also be influenced by a user's preference on what he or she would like to see or a revenue relevance to the fingerprint database or by businesses to the owner of the fingerprint database or based on reviews of rooms by users.

Similar to a review of a business on third party web sites, a review of a room on a fingerprint database would be a way for a user to express an opinion of a room in one or more ways, including but not limited numerical ranking or grade, a number of stars, a picture, video, or audio clip which may or may not need to be taken in the room, or text.

In one embodiment of the review of a room, the user would actually need to be present in said room to post the review of the room. Or, in a different embodiment, the user could post a review of any room within a room type, as long as the user was in a room of that type.

1. A system for collecting and displaying localized data of a plurality of elements relative to a plurality of containers, the system comprising:
fingerprint database memory for storing a plurality of dynamic input maps, the dynamic input maps representing a plurality of input data regarding a plurality of elements in known relation to a plurality of reference points for a plurality of containers;
a touchscreen user interface for configuring the dynamic input maps, for configuring the containers with a plurality of container attributes and for configuring the elements with a plurality of element attributes, for inputting a plurality of additional data regarding the elements and the containers, and for displaying the dynamic input maps; and
a processor for receiving the input data, for building a database concerning the element attributes and the container attributes and for building the dynamic input maps.

2. The system from claim 1, where the dynamic input map is configured to display in a grid format.

3. The system from claim 1, where the dynamic input map is configured to display in non-grid format.

4. The system from claim 1, where the dynamic input map displays social demographics of people in a room.

5. The system from claim 1, where the size, color, shape, or visual attributes of the visual representation of inputs are based on a plurality of relevance factors that are chosen by the user.

6. A system for collecting and displaying localized data of a plurality of elements relative to a plurality of containers, the system comprising:
fingerprint database memory for storing a plurality of dynamic input maps, the dynamic input maps representing a plurality of input data regarding a plurality of elements in known relation to a plurality of reference points for a plurality of containers;
a touchscreen user interface for configuring the dynamic input maps, for configuring the containers with a plurality of container attributes and for configuring the elements with a plurality of element attributes, for inputting a plurality of additional data regarding the elements and the containers, and for displaying the dynamic input maps;
a processor for receiving the input data, for building a database concerning the element attributes and the container attributes and for building the dynamic input maps;
wherein the processor identifies anomalies in the aggregate fingerprint database of containers in real-time to facilitate management opportunities.

7. The system from claim 6, where the container display can be manually reordered by the user.

8. The system from claim 6, where the aggregate view is created from property which the user owns, manages, leases, or otherwise does business, including, but not limited to, an assembly view of properties collected from third party software.

9. A system for collecting and displaying localized data of a plurality of elements relative to a plurality of containers, the system comprising:
fingerprint database memory for storing a plurality of dynamic input maps, the dynamic input maps representing a plurality of input data regarding a plurality of elements in known relation to a plurality of reference points for a plurality of containers;
a touchscreen user interface for configuring the dynamic input maps, for configuring the containers with a plurality of container attributes and for configuring the elements with a plurality of element attributes, for inputting a plurality of additional data regarding the elements and the containers, and for displaying the dynamic input maps;
a processor for receiving the input data, for building a database concerning the element attributes and the container attributes and for building the dynamic input maps; and
an algorithm that determines the relevance factor of a container for display purposes allowing the user to display containers that are not grid related.

10. The method of claim 9, where the relevance factor's rank is determined by the people (or the relationship to the people) who have visited the room in the past, the people who are currently in the room, the people who are likely to visit the room in the future, and the people who have committed to visiting the room in the future.

11. The system from claim 9, where the relevance factor is user-generated, based on the time spent in a particular place.

12. The method of claim 9, where the relevance factor is influenced by revenue relevance such as advertising money, payments from businesses, or payments from users.

13. The method of claim 9, where the relevance factor rank is communicated to the user because of personal relevance factors.

14. The method of claim 9, where the relevance factor rank is determined by the personal information of the people who have visited the room in the past or present.

15. The method from claim 9, where the relevance factor rank dynamically modifies the visual appearance of the containers.

16. The method from claim 9, where the relevance factor rank is determined by the amount of device activity occurring in a particular room, including the sensor data, pictures taken, sound processed, and signal strengths received on devices inside of a room or inside the building which the room is located.

17. The method from claim 9, where the relevance factor rank is an algorithm based on user information such as compilations, rankings, ratings, reviews, referrals and recommendations.
